(19) United States
(12) Patent Application Publication
(10) Pub. No.: US 2013/0144953 A1
(43) Pub. Date: Jun. 6, 2013

(54) COMPUTER SYSTEM AND DATA MANAGEMENT METHOD

(71) Applicant: Satoru Watanabe, Yokohama (JP)

(72) Inventor: Satoru Watanabe, Yokohama (JP)

(73) Assignee: HITACHI, LTD., Tokyo (JP)

(21) Appl. No.: 13/813,987

(22) PCT Filed: Jan. 25, 2011
(86) PCT No.: PCT/JP2011/051347

§ 371 Date: Feb. 4, 2013

(30) Foreign Application Priority Data
Aug. 6, 2010 (JP) 2010-176992

(51) Int. Cl. H04L 29/06

(52) U.S. Cl. CPC H04L 65/403
USPC 709/204

(57) ABSTRACT

Provided is a computer system provided with: a plurality of execution servers that execute a plurality of jobs; and a scheduling server that is connected to the execution servers. The execution servers hold a plurality of data that are processed by the jobs, and the scheduling server generates a plurality of first sets that each contain a plurality of data processed by the plurality of jobs that are continuously executed, extracts, from the plurality of first sets, second sets containing data held by one of the execution servers and data held by another execution server, and determines data contained in the extracted second sets to be data to be transferred to a newly added execution server.

### CROSS-REFERENCE TO RELATED APPLICATION

The present application claims a right of priority to Japanese Patent Application No. 2010-176992 which was filed on Aug. 6, 2010 and the contents of which are incorporated herein by reference.

### TECHNICAL FIELD

The present invention relates to a computer system, or more particularly, to a computer system that determines data to be moved in case a server is newly added to the computer system.

### BACKGROUND ART

Currently, a system that uses a scheduler and servers, which execute jobs, to execute jobs is widely employed. The system includes the scheduler that receives a request for execution of a job and transmits the received request to a server (hereinafter, execution server), which executes a job), and the execution servers.

The scheduler in the system analyzes a job request, that is, a request concerning a job, determines an execution server that executes the requested job, and transmits a request for execution of the job to the determined execution server (refer to, for example, patent literature 1).

In addition, a technology for storing data in a memory of a job execution server has been proposed (refer to, for example, patent literature 2). In the patent literature 2, a proposal is made of a system that stores data, which is used in a job, in a memory of an execution server (main storage device).

Further, in a system including a scheduler and execution servers, if the processing capacity of the system is short, the processing capacity of the system is increased by adding an execution server. Such a system has been proposed. Adding an execution server is called scale-out of an execution server. Thus, the system that increases its processing capacity through scale-out has been proposed (refer to, for example, patent literature 3).

### CITATION LIST

### Patent Literature

Patent literature 1: Japanese Unexamined Patent Application Publication No. 2008-152618
Patent literature 2: Japanese Unexamined Patent Application Publication No. Hei7-334402
Patent literature 3: Japanese Unexamined Patent Application Publication No. 2009-110129

### SUMMARY OF INVENTION

### Technical Problem

In a system in which data is preserved in a memory of each of execution servers, when an execution server is scaled out, part of data items preserved in the existing execution servers has to be moved to the execution server to be added.

If loads imposed on the execution servers get unbalanced, the execution server on which an excessive load is imposed becomes a bottleneck, that is, causes a delay in processing. There arises a possibility that overall processing may be stagnated. Therefore, when an execution server is scaled out, data has to be moved so that the loads imposed on the execution servers can be leveled.

Jobs to be executed in the system fall into jobs that perform processing with one data as an argument and jobs that process plural data items.

For example, in a bank account deposit/withdrawal system, data of an account number and data of an account balance are managed while being associated with each other. In such a deposit/withdrawal system, a job that withdraws from one account and deposits in another account is executed. Such a job processes plural data items such as data of the account number of the account from which money is withdrawn, data of the account balance thereof, data of the account number of the account in which money is deposited, and data of the account balance thereof.

A job that processes plural data items shall be referred to as a linkage job.

If data items to be processed by a linkage job are stored in different execution servers, after one of the servers terminates preceding processing (for example, withdrawal processing), the server notifies the other execution server of the fact that the preceding processing has been terminated. After receiving the fact, the other execution server executes succeeding processing (for example, deposit processing).

As mentioned above, if data items to be processed by a linkage job are stored in different execution servers, one of the execution servers has to communicate with the other execution server. Because of an overhead in the communication, system performance is degraded. Therefore, the data items to be processed by the linkage job are preferably disposed in the same execution server.

The first object of the present invention is to, in case an execution server is scaled out, appropriately determine data, which is moved to the execution server to be added, so as to achieve leveling of loads on execution servers, reduction of an overhead in communication of a linkage job, or both of them.

A job that is not a linkage job may access data according to a specific pattern. For example, such a job is found that accesses data according to a specific pattern signifying that a possibility of processing another data (data 2) after processing certain data (data 1) is high.

In the foregoing example, if the data 1 and data 2 are stored in different execution servers, a scheduler waits until processing of the data 1 is completed, and instructs the execution server to process the data 2 after the processing of the data 1 is completed. This is intended to guarantee an order in which data items are processed.

By the way, in the foregoing example, if the data 1 and data 2 are stored in the same execution server, the execution server executes jobs in the order in which the execution server is instructed to execute the jobs. Therefore, the scheduler can instruct processing of the data 2 without the necessity of waiting until processing of the data 1 is completed. Therefore, in order to diminish processing to be performed by the scheduler, the data 1 and data 2 are preferably disposed in the same execution server.

The second object of the present invention is to, in case an execution server is scaled out, appropriately determine data, which is moved to the execution server to be added, so as to achieve leveling of loads on execution servers, reduction of a processing load on a scheduler due to a difference in an access pattern to data, or both of them.

### Solution to Problem

A typical example of the present invention to be disclosed in this description will be presented below. Specifically, a computer system includes plural execution servers that execute plural jobs, and a scheduler server connected to the execution servers. Herein, the execution servers each preserve plural data items to be processed by the jobs. The scheduler server produces plural first pairs each including plural data items to be processed by the plural jobs that are successively executed, extracts a second pair, which includes data preserved by one of the execution servers, and data preserved by any other execution server, from among the plural first pairs, and determines the data items, which are included in the extracted second pair, as data items to be moved to the execution server that is newly added.

### Advantageous Effects of Invention

According to a typical embodiment of the present invention, loads on execution servers can be leveled, and an overhead in communication can be reduced.

### BRIEF DESCRIPTION OF DRAWINGS

FIG. 1 is a block diagram showing a configuration of a computer system of an embodiment of the present invention;

FIG. 2 is an explanatory diagram showing data items in the embodiment of the present invention;

FIG. 3 is an explanatory diagram showing pieces of information contained in a job/data disposition table in the embodiment of the present invention;

FIG. 4 is an explanatory diagram showing a data use frequency table in the embodiment of the present invention;

FIG. 5 is an explanatory diagram showing an access pattern management table in the embodiment of the present invention;

FIG. 6 is a flowchart presenting a procedure according to which a moving data determination unit determines data items to be moved to an execution server in the embodiment of the present invention;

FIG. 7 is an explanatory diagram showing an execution server load list in the embodiment of the present invention; and

FIG. 8 is a flowchart presenting a procedure of determining data items, which are moved to an execution server, by giving priority to a communication frequency in the embodiment of the present invention.

### DESCRIPTION OF EMBODIMENTS

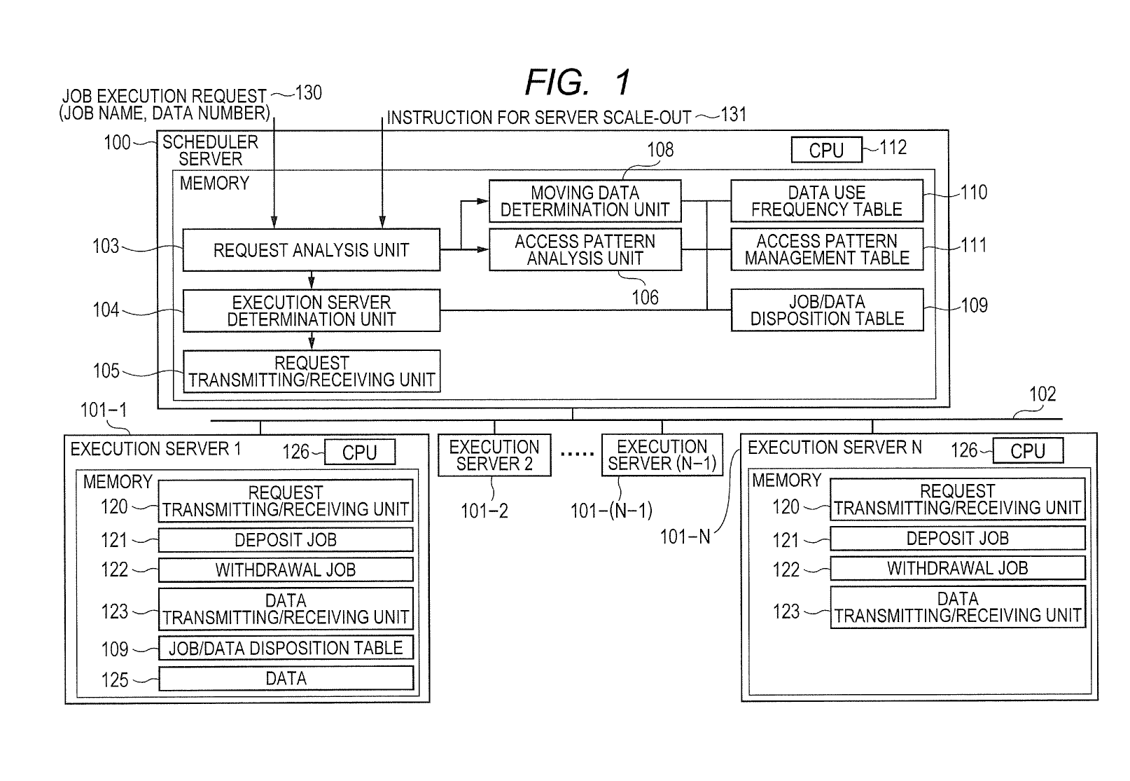

FIG. 1 is a block diagram showing a configuration of a computer system of an embodiment of the present invention.

A computer system shown in FIG. 1 includes a scheduler server 100 and one or more execution servers 101 (execution servers 101-1, 101-2, etc., and 101-(N−1)). Reference numeral 101-N denotes an execution server 101 to be added to the computer system in accordance with the present embodiment. The scheduler server 100 and execution servers 101 are interconnected over a network 102.

The scheduler server 100 is a computer including a CPU 112 and memory. The scheduler server 100 includes a request analysis unit 103, execution server determination unit 104, request transmitting/receiving unit 105, access pattern analysis unit 106, moving data determination unit 108, job/data disposition table 109, data use frequency table 110, and access pattern management table 111.

The request analysis unit 103, execution server determination unit 104, request transmitting/receiving unit 105, access pattern analysis unit 106, and moving data determination unit 108 are stored in a memory of the scheduler server 100, and implemented by programs that are stored in the memory of the scheduler server 100 and run by the CPU 112. The job/data disposition table 109, data use frequency table 110, and access pattern management table 111 are tables stored in the memory of the scheduler server 100.

The memory of the scheduler server 100 can store programs and data items. In addition, data or the like can be tentatively stored.

The request analysis unit 103 is implemented by a program that analyzes a request or the like sent from an administrator, user, or another scheduler server 100, and transmits information included in the request to each program. The access pattern analysis unit 106 is implemented by a program that measures the use frequency of data 125 stored in each of the execution servers 101.

The execution server determination unit 104 is implemented by a program that determines the execution server 101 which executes a job requested with a job execution request 130. The request transmitting/receiving unit 105 is implemented by a program that transmits information on a job, which is requested to be executed, to the execution server 101 determined by the execution server determination unit 104. The request transmitting/receiving unit 105 receives a result of execution of a job from the execution server 101.

The moving data determination unit 108 is implemented by a program that, when the execution server 101 is added, determines data 125 which is moved from the existing execution server 101 to the added execution server 101.

The execution servers 101 are computers each including a CPU 126 and memory. The execution servers 101-1 to 101-(N−1) each include a request transmitting/receiving unit 120, deposit job 121, withdrawal job 122, data transmitting/receiving unit 123, job/data disposition table 109, and data 125. The execution server 101-N includes the request transmitting/receiving unit 120, deposit job 121, withdrawal job 122, and data transmitting/receiving unit 123.

The request transmitting/receiving unit 120 and data transmitting/receiving unit 123 included in the execution server 101 are implemented by programs that are stored in the memory of the execution server 101 and run by the CPU 126. The deposit job 121 and withdrawal job 122 are jobs including programs to be run by the CPU 126.

The job/data disposition table 109 and data 125 (any of data 125-1 to 125-(N−1)) included in each of the execution servers 101-1 to 101-(N−1) are a table and data to be stored in the memory of the execution server 101.

The request transmitting/receiving unit 120 is implemented by a program that receives information on a job, which is requested to be executed, transmitted from the scheduler server 100, and transmits a result of execution of the job to the scheduler server 100. The data transmitting/receiving unit 123 is implemented by a program that transmits or receives the data 125 to or from the execution server 101.

The deposit job 121 is a job that adds a numeral, which is given with an argument, to a value contained in the data 125. The withdrawal job 122 is a job that subtracts a numeral, which is given with the argument, from the value contained in the data 125.

The execution server 101-N is an execution server 101 to be newly added to the computer system of the present embodiment, that is, an execution server 101 to be scaled out. Before the execution server 101-N is added to the computer system of the present embodiment, the execution server 101-N is devoid of the job/data disposition table 109 and data 125. The scheduler server 100 in the present embodiment determines the data 125, which is stored in the execution server 101-N, for the purpose of adding the execution server 101-N.

The scheduler server 100 and execution servers 101 shown in FIG. 1 are implemented by different computers. Alternatively, the scheduler server 100 and execution servers 101 in the present embodiment may be implemented by virtual computers. The virtual computers are implemented by at least one physical CPU and at least one physical memory.

The execution servers 101 shown in FIG. 1 each preserve the deposit job 121 and withdrawal job 122. Alternatively, the execution servers 101 in the present embodiment may preserve any jobs that are not limited to the deposit job 121 and withdrawal job 122 as long as the jobs are executed by programs.

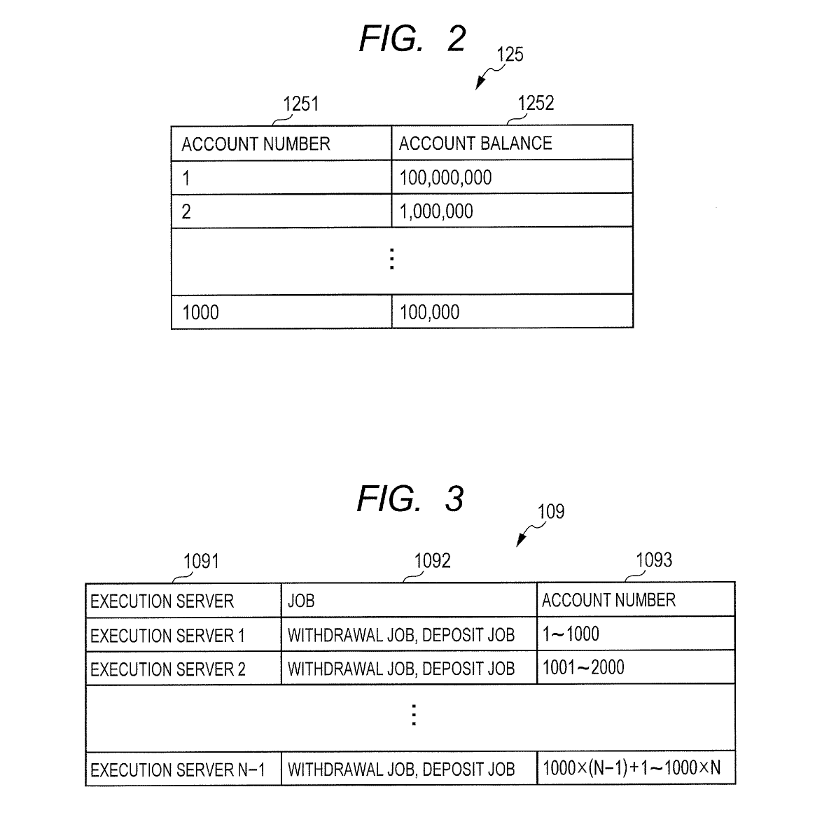

FIG. 2 is an explanatory diagram showing the data items 125 in the embodiment of the present invention.

The data 125 is data which the execution server 101 processes by means of a job.

The data 125 includes an account number 1251 and account balance 1252. The account number 1251 represents an identifier that uniquely indicates each data 125, and the account balance 1252 represents a value of each data 125.

In the execution servers 101-1 to 101-(N−1), different data items 125-1 to 125-(N−1) are stored. For example, in the execution server 101-1, the data items 125 whose account numbers 1251 range from 1 to 1000 are stored. In the execution server 101-2, the data items 125 whose account numbers 1251 range from 1001 to 2000 are stored. In the execution server 101-(N−1), the data items 125 whose account numbers 1251 range from 1000×(N−1)+1 to 1000×N are stored.

FIG. 3 is an explanatory diagram showing the job/data disposition table 109 in the embodiment of the present invention.

The job/data disposition table 109 is preserved by the scheduler server 100 and execution servers 101. The job/data disposition table 109 presents the relationship of association among the execution servers 101, types of jobs, which are executed by the execution servers 101, and data items to be processed by the execution servers 101. The job/data disposition table 109 is updated when the execution server 101 is scaled out. The updated job/data disposition table 109 is transmitted to the execution servers 101 by the scheduler server 100.

The job/data disposition table 109 includes execution servers 1091, jobs 1092, and account numbers, 1093. The execution servers 1091 are identifiers uniquely specifying the execution servers 101. The job/data disposition table 109 includes entries for the respective execution servers 101.

The jobs 1092 include types of jobs executable by the execution servers 101 specified by the execution servers 1091. The account numbers 1093 include identifiers of data items 125, that is, the account numbers 1251 shown in FIG. 2. The account number 1093 may include plural identifiers.

For example, as shown in FIG. 3, assuming that the execution servers 1091 are the execution servers 101-1 to 101-(N−1) and the jobs 1092 are a deposit job and withdrawal job, the job/data deposition table 109 signifies that the execution servers 101-1 to 101-(N−1) can execute the deposit job and withdrawal job.

Now, what is referred to as a deposit job specified in the job/data deposition table 109 is a job that adds an inputted argument to the account balance 1252 of the data 125, and a job that is executed by the deposit job 121. What is referred to as a withdrawal job specified in the job/data deposition table 109 is a job that subtracts the inputted argument from the account balance 1252 of the data 125, and a job that is executed by the withdrawal job 122.

Assuming that the execution server 1091 specifies the execution server 101-1 and the account number 1093 specifies 1 to 1000, the data items 125 whose account numbers 1251 shown in FIG. 2 range from 1 to 1000 are stored in the execution server 101-1. Assuming that the execution server 1091 specifies the execution server 101-2 and the account number 1093 specifies 1001 to 2000, the data items 125 whose account numbers 1251 shown in FIG. 2 range from 1001 to 2000 are stored in the execution server 101-2.

Assuming that the execution server 1091 specifies the execution server 101-(N−1) and the account number 1093 specifies 1000×(N−1)+1 to 1000×N, data items whose account numbers 1251 range from 1000×(N−1)+1 to 1000×N are stored in the execution server 101-(N−1).

In each of the entries of the jobs 1092 in FIG. 3, a deposit job 121 and a withdrawal job 122 are contained. Alternatively, plural deposit jobs 121 or withdrawal jobs 122 may be contained.

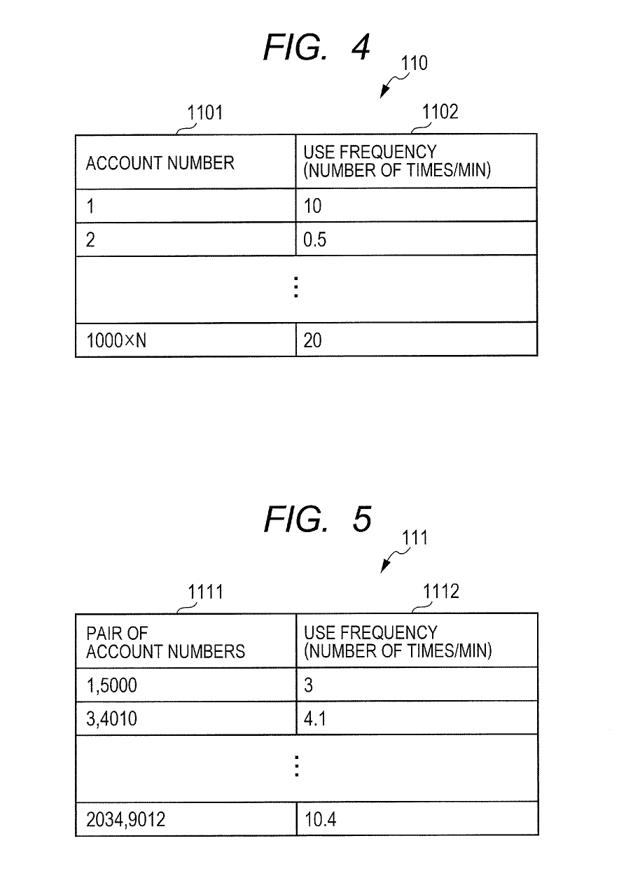

FIG. 4 is an explanatory diagram presenting the data use frequency table 110 in the embodiment of the present invention.

The data use frequency table 110 is preserved by the scheduler server 100. The data use frequency table 110 presents the use frequencies of the data items 125, that is, frequencies at which the respective entries of the data items 125 are handled by jobs.

The data use frequency table 110 includes account numbers 1101 and user frequencies 1102. The account numbers 1101 specify identifiers of the data items 125 and correspond to the account numbers 1251 shown in FIG. 2 and the account numbers 1093 shown in FIG. 3. The use frequencies 1102 specify frequencies at which the respective data items 125 specified by the account numbers 1101 are each processed per min by a job.

The data use frequency table 110 shown in FIG. 4 is a table in which the use frequencies 1102 are contained in association with the account numbers 1101. In order to decrease the number of entries of the data use frequency table 110, the data items 125 may be grouped in units of a predetermined number of entries so that plural data use frequency tables 110 can be produced. Specifically, entries whose account numbers 1101 range from 1 to 100 and entries whose account numbers 1101 range from the execution server 101 to 200 are grouped respectively, so that the use frequencies 1102 can be included in the plural data use frequency tables 110.

FIG. 5 is an explanatory diagram presenting the access pattern management table 111 in the embodiment of the present invention.

The access pattern management table 111 includes pairs of account numbers 1111 and use frequencies 1112. The pair of account numbers 1111 specifies a pair of data items 125 arising in case after one data 125 is processed, another data 125 is processed. Values specified by the pair of account numbers 111 are equivalent to values of the account numbers 1251 shown in FIG. 2, values of the account numbers 1093 shown in FIG. 3, and values of the account numbers 1101 shown in FIG. 4. Herein, the data items 125 contained in the pair of account numbers 1111 may not only be a pair of data items 125 to be successively processed by a linkage job but also be a pair of data items 125 that exhibits a high possibility of being processed within a certain period of time when an ordinary job is executed.

The use frequencies 1112 specify frequencies at which the respective pairs of data items 125 specified by the pairs of account numbers 1111 are processed. The use frequency 1112 specifies a frequency at which the pair of data items 125 specified by the pair of account numbers 1111 is processed per min by a job.

The access pattern management table 111 shown in FIG. 5 is a table in which the use frequencies 1112 are contained in association with the respective pairs of account numbers 1111. In order to decrease the number of entries of the access pattern management table 1111, data items may be grouped in units of a predetermined number of data items so that plural access pattern management tables 111 can be produced.

Specifically, for example, the first group of values of data items 125 included in the pairs of account numbers 1111 may range from 1 to 100, and the second group of values of data items 125 included in the pairs of account numbers 1111 may range from 1000 to 1100. Thus, entries may be grouped so that the use frequencies 1112 can be contained in plural access pattern management tables 111.

In the pairs of account numbers 1111 in FIG. 5, values of two account numbers 1101 are contained. Alternatively, values of three or more account numbers 1101 may be contained.

The data 125 in the present embodiment is not limited to the account number 1251 and account balance 1252, but may be any kind of data as long as the data includes an identifier with which each data 125 is uniquely identified, and a value. Therefore, the column names of the job/data disposition table 109, data use frequency table 110, and access pattern management table 111 may be different ones according to the kind of data contained as the data 125.

### (Scheduling Jobs)

After a job execution request 130 is sent from an administrator, user, or another scheduler server 100, the scheduler server 100 allows the execution server 101 to execute a job requested with the job execution request 130. The job execution request 130 includes information that uniquely represents a job to be executed, and information that uniquely represents data 125 to be processed by the job to be executed. If necessary, an argument or the like to be inputted to the job is included in the job execution request 130.

For example, the job execution request 130 in the present embodiment includes information that requests “execution of a withdrawal job of withdrawing 1 yen from an account of an account number 1.” In this case, the “number 1” refers to information that uniquely represents data 125, the “withdrawal job” refers to information that uniquely represents a job being executed, and the “1 yen” refers to an argument. The values included in the job execution request 130 should uniquely represent the data 125 and job respectively, and may be identifiers or names.

If the job execution request 130 includes information that represents a request for execution of a linkage job, the job execution request 130 includes two or more pieces of information that represent each of a job and data 125. For example, the job execution request 130 includes information that requests “execution of a deposit job of depositing 1 yen in an account of an account number 2.”

As long as the job execution request 130 includes the foregoing information, it may be designated according to any method. The Job execution request 130 may be described in, for example, a common separated values (CSV) format.

After the scheduler server 100 receives the job execution request 130, the request analysis unit 103 extracts a job name and an identifier, which specifies data 125, from the job execution request 130, and transmits them to the access pattern analysis unit 106 and execution server determination unit 104.

The access pattern analysis unit 106 measures the use frequencies of data items 125, which are stored in all the execution servers 101, at intervals of a certain time of, for example, 1 min. The access pattern analysis unit 106 then updates the use frequencies 1102 of the data use frequency table 110 and the use frequencies 1112 of the access pattern management table 111 to the latest values.

When executing a job, the execution server 101 transmits information, which represents processed data 125 and a job, to the scheduler server 100. Therefore, when the information is transmitted from the execution server 101, the scheduler server 100 measures the use frequency of the data 125. After one data 125 is processed, the access pattern analysis unit 106 measures a frequency, at which another data 125 is processed, for a certain period of time.

After information representing a job and data 125 is sent from the request analysis unit 103, the access pattern analysis unit 106 measures the user frequencies of the data items 125, which are stored in each of the execution servers 101, for a certain period of time on the basis of information representing the data 125 and being received from the request analysis unit 103. Based on the measured use frequencies, the access pattern analysis unit 106 updates use frequencies 1102 of the data use frequency table 110 and use frequencies 1112 of the access pattern management table 111.

More particularly, when receiving information that requests “execution of a withdrawal job of withdrawing 1 yen from an account of an account number 1,” the access pattern analysis unit 106 measures the user frequency of the data 125, the account number 1251 of which is 1, for a certain period of time of, for example, 1 min. With the measured use frequency, the data use frequency table 110 is updated.

Assuming that the access pattern analysis unit 106 receives information that requests “execution of a withdrawal job of withdrawing 1 yen from an account of an account number 1 and execution of a deposit job of depositing 1 yen in an account of an account number 2,” the access pattern analysis unit 106 measures the use frequencies of the data 125 whose account number 1251 is 1 and the data 125, the account number 1251 of which is 2, for a certain period of time, and updates the access pattern management table 111.

At any time other than when the access pattern analysis unit 106 receives a linkage job execution request, the access pattern analysis unit 106 may update the access pattern management table 111. For example, the access pattern analysis unit 106 measures a frequency at which the fact that after the data 125 whose account number 1251 is 1 is processed, the data whose account number 1251 is 2 is processed is transmitted from the execution server 101.

Assuming that the frequency sent from the execution server 101 exceeds a predetermined frequency, the access pattern analysis unit 106 contains a pair of the data 125, the account number 1251 of which is 1, and the data 125, the account number 1251 of which is 2, in the pair of account numbers 1111 in the access pattern management table 111, and contains the frequency, which is sent from the execution server 101, in the use frequency 1112.

When updating the data use frequency table 110 and access pattern management table 111, the access pattern analysis unit 106 may calculate a mean of a previously measured use frequency 1102 or use frequency 1112 and a newly measured use frequency 1102 or use frequency 1112, and contain the calculated mean value in the use frequency 1102 or use frequency 1112. In addition, the access pattern analysis unit 106 may delete the previously measured use frequency 1102 or use frequency 1112 and contain the newly measured use frequency 1102 or use frequency 1112.

After information representing a job and data 125 is sent from the request analysis unit 103, the execution server determination unit 104 references the job/data disposition table 109, and extracts the job 1092 and account number 1093 represented by the information sent from the request analysis unit 103. The execution server determination unit 104 then determines the execution server 1091, which is associated with the extracted job 1092 and account number 1093, as the execution server 101 that executes the job requested with the job execution request 130. The determined execution server 101 and the job to be executed are transmitted to the request transmitting/receiving unit 105.

The request transmitting/receiving unit 105 transmits a request for execution of a job to the request transmitting/receiving unit 120 of the execution server 101 determined by the execution server determination unit 104. At this time, the request to be sent to the request transmitting/receiving unit 120 includes information included in the job execution request 130.

After the request transmitting/receiving unit 120 receives a request for execution of a job from the request transmitting/receiving unit 105, the CPU 126 of the execution server 101 executes the job according to information included in the request. After the CPU 126 executes the job, the request transmitting/receiving unit 120 transmits a result of execution of the job to the request transmitting/receiving unit 105.

As mentioned above, after the job execution request 130 is inputted to the computer system of the present embodiment, the execution server 101 executes a requested job. Herein, if the inputted job execution request 130 requests execution of a linkage job, the job may be executed by plural execution servers 101.

For example, assuming that the job execution request 130 requests “execution of a withdrawal job of withdrawing 1 yen from an account of an account number 1 and execution of a deposit job of depositing 1 yen in an account of an account number 1001,” the scheduler server 100 first determines the execution server 101, which executes the first job, according to the aforesaid procedure. Herein, if the execution server determination unit 104 determines the execution server 101-1 as the execution server 101 that executes the first job, the request transmitting/receiving unit 105 transmits a request for execution of the withdrawal job 122 to the execution server 101-1.

Thereafter, after the CPU 126 of the execution server 101-1 completes the withdrawal job 122, the CPU 126 of the execution server 101-1 references the job/data deposition table 109, and determines the execution server 101 that executes the second job. Herein, assuming that the CPU 126 determines the execution server 101-2 as the second job execution server 101, the CPU 126 of the execution server 101-1 transmits a request for execution of the job to the execution server 101-2. At this time, the request transmitting/receiving unit 120 of the execution server 101-1 and the request transmitting/receiving unit 120 of the execution server 101-2 transmit or receive the job execution request.

(Determining Data 125 to be Moved Due to Scale-Out)

Assuming that the execution server 101-N is added to the computer system of the present embodiment, a command for server scale-out 131 is inputted to the scheduler server 100 by an administrator or the like.

The command for server scale-out 131 includes a threshold of communication frequencies. What is referred to as the threshold of communication frequencies is a value which an administrator or the like uses to designate a frequency of communication between the execution servers 101 which arises for the purpose of executing a linkage job. The communication frequency in the present embodiment is a communication frequency arising among the existing execution servers 101, that is, the execution servers 101-1 to 101-(N−1). The threshold of communication frequencies may be designated by the administrator or the like using the command for server scale-out 131, or may be stored in advance in the scheduler server 100.

When the threshold of communication frequencies is designated, the moving data determination unit 108 of the scheduler server 100 determines data 125, which is moved to the execution server 100-N, so that the communication frequency becomes equal to or smaller than the designated threshold of communication frequencies. The threshold of communication frequencies is designated with, for example, the number of times of communication per 1 min.

In addition, the command for server scale-out 131 includes information representing a leveling preference, communication reduction preference, or both of them. What is referred to as the leveling preference is an instruction signifying that data 125 should be moved to the added execution server 101-N on the basis of the use frequency of the data 125 so that loads on all the execution servers 101 can be leveled. What is referred to as the communication reduction preference is an instruction signifying that data items 125 should be moved so that data items 125 to be processed by a linkage job can be stored in the same execution server 101.

The command for server scale-out 131 in the present embodiment specifies either the leveling preference or communication reduction preference according to a threshold of communication frequencies. Specifically, if the threshold of communication frequencies is designated as zero times per min, the command for server scale-out 131 specifies the communication reduction preference. If the threshold of communication frequencies is designated as infinity, the command for server scale-out 131 specifies the leveling preference.

If the threshold of communication frequencies is a value between zero times per min and infinity, the command for server scale-out 131 specifies both the leveling preference and communication reduction preference. According to whether the threshold of communication frequencies is large or small, the command for server scale-out 131 signifies whichever of the leveling preference and communication reduction preference should be given priority.

When the execution server 101-N is added, the moving data determination unit 108 is implemented by a program that determines data 125 to be moved to the execution server 101-N.

When the command for server scale-out 131 is inputted to the scheduler server 100, the request analysis unit 103 transmits information, which is represented by the command for server scale-out 131, to the moving data determination unit 108. On receipt of the information, which is represented by the command for server scale-out 131, from the request analysis unit 103, the moving data determination unit 108 determines data 125, which is moved to the newly added execution server 101-N, according to the information represented by the command for server scale-out 131.

Processing of the scheduler server 100 for determining data 125 to be moved to the added execution server 101 will be presented below.

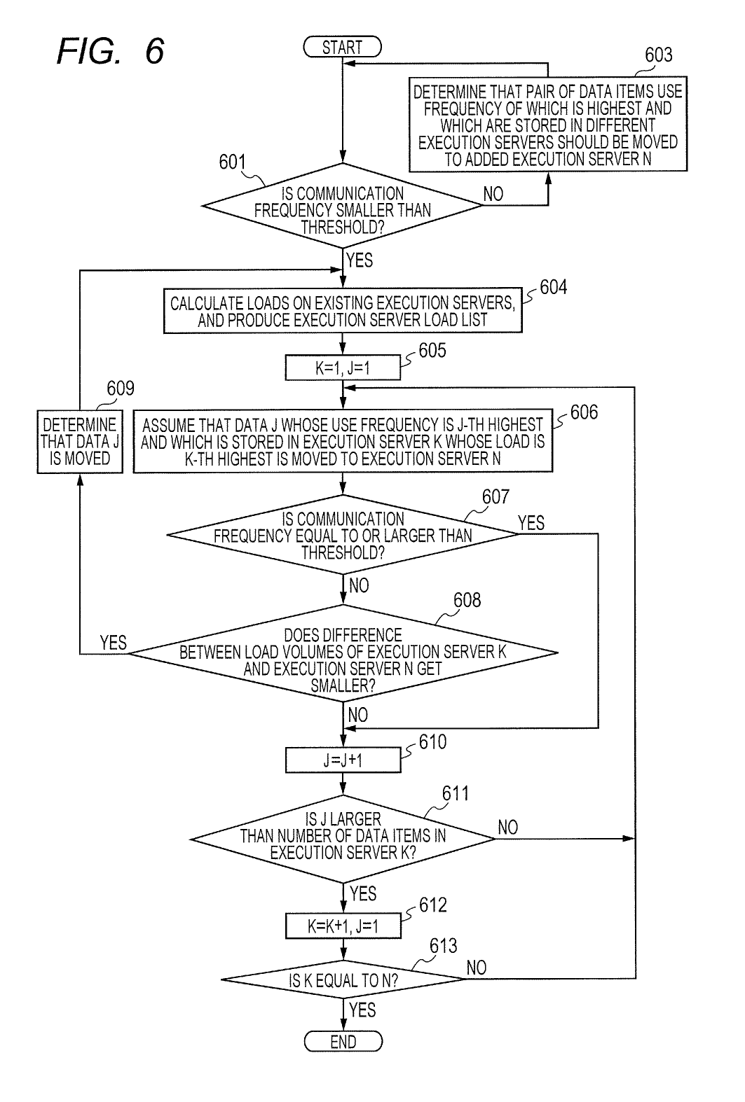

FIG. 6 is a flowchart presenting a procedure of the moving data determination unit 108 for determining data 125, which is moved to the execution server 101-N, in accordance with the embodiment of the present invention.

Referring to the flowchart of FIG. 6, the processing of the moving data determination unit 108 will be described below. The processing of the moving data determination unit 108 shown in FIG. 6 includes a step of determining data 125 to be moved in order to reduce a communication frequency among the execution servers 101, and a step of determining the data 125 to be moved in order to level load volumes of all the execution servers 101.

At step 601 and step 603, the moving data determination unit 108 determines data 125 that is moved in order to reduce a communication frequency.

First, the moving data determination unit 108 decides whether the communication frequency among the execution servers 101 is larger than the threshold of communication frequencies designated with the command for server scale-out 131 (601). More particularly, the moving data determination unit 108 references the job/data deposition table 109 so as to extract entries, each of which includes the pair of account numbers 1111 specifying a pair of data items 125 stored in different execution servers 101, out of the entries of the access pattern management table 111. The moving data determination unit 108 then summates the use frequencies 1112 in all of the extracted entries. Accordingly, the moving data determination unit 108 calculates the communication frequency among the existing execution servers 101, that is, among the execution servers 101-1 to 101-(N−1).

Further, the moving data determination unit 108 compares the threshold of communication frequencies, which is designated with the command for server scale-out 131, with the calculated communication frequency among the execution servers 101-1 to 101-(N−1) at step 601. The moving data determination unit 108 then decides whether the communication frequency among the execution servers 101-1 to 101-(N−1) is equal to or larger than the threshold of communication frequencies designated with the command for server scale-out 131.

If a decision is made at step 601 that the communication frequency among the execution servers 101-1 to 101-(N−1) is equal to or larger than the threshold of communication frequencies designated with the command for server scale-out 131, the moving data determination unit 108 proceeds to step 603 so as to reduce the communication frequency among the execution servers 101.

Subsequently to step 601, the moving data determination unit 108 selects an entry, in which the use frequency 1112 is the largest, from among the pairs of account numbers 1111 each of which specifies the pair of data items 125 stored in different execution servers 101 and which are extracted at step 601. Based on the selected entry, the moving data determination unit 108 determines that the pair of data items 125, which exhibits the highest use frequency 1112 and is stored in the different execution servers 101, is moved to the execution server 101-N (603).

In addition, the moving data determination unit 108 updates, the job/data disposition table 109 at step 603 so that the pair of data items 125 determined to be moved to the execution server 101-N can be associated with the execution server 101-N.

Subsequently to step 603, the moving data determination unit 108 repeats step 601 and step 603 until the communication frequency among the execution servers 101-1 to 101-(N−1) becomes equal to or smaller than the threshold of communication frequencies designated with the command for server scale-out 131.

If a decision is made at step 601 that the communication frequency among the execution servers 101-1 to 101-(N−1) is smaller than the threshold of communication frequencies designated with the command for server scale out 131, the communication frequency among the execution servers is an acceptable frequency. It is unnecessary to change the communication frequency among the execution servers 101. The moving data determination unit 108 therefore proceeds to step 604.

At step 604 to step 613, the moving data determination unit 108 determines data 125 to be moved for the purpose of leveling the loads on the execution servers 101.

Subsequently to step 601, the moving data determination unit 108 calculates a load volume of each of the execution servers 101-1 to 101-(N−1), and produces an execution server load list 113 (604). More particularly, the moving data determination unit 108 references the data use frequency table 110 and job/data disposition table 109, and summates the use frequencies 1101 in the data use frequency table 110 in relation to each of the execution servers 101. Thus, the load volume of each of the execution servers 101 is calculated. At step 604, the moving data determination unit 108 produces the execution server load list 113 in which pieces of information representing the execution servers 101 are sorted in descending order of the calculated load volume.

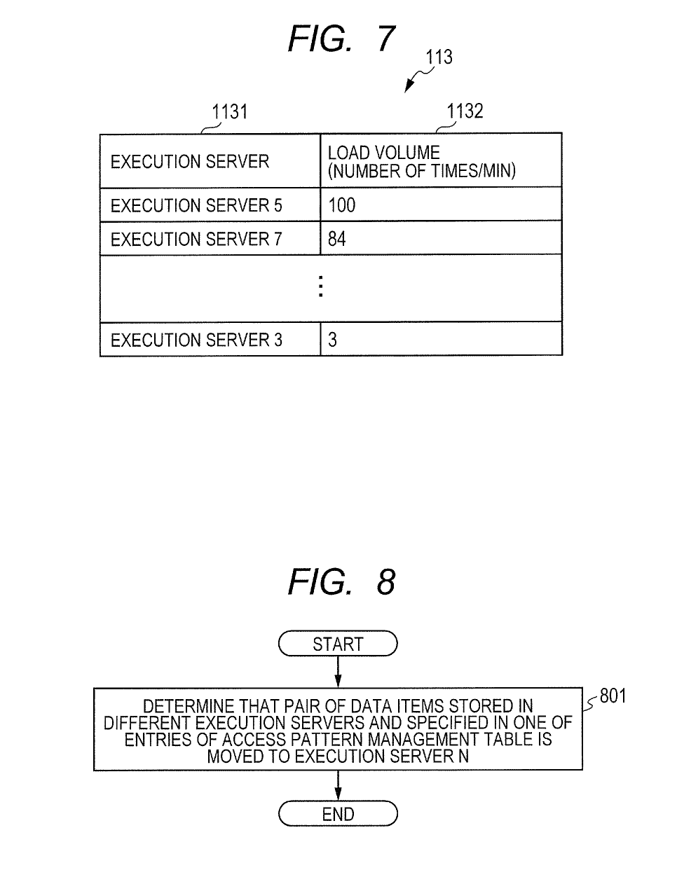

FIG. 7 is an explanatory diagram showing the execution server load list 113 in the embodiment of the present invention.

The execution server load list 113 includes execution servers 1131 and load volumes 1132. The execution servers 1131 are identifiers or names that uniquely represent the execution servers 101. The load volumes 1132 are load volumes calculated at step 604.

In the execution server load list 113, entries are contained in descending order of the load volume 1132. In the execution server load list 113 shown in FIG. 7, the load volumes 1132 are sorted in descending order. As long as the moving data determination unit 108 can recognize whether the load volumes 1132 are large or small, the load volumes may be sorted in ascending order.

Subsequently to step 604, the moving data determination unit 108 stores as initial settings 1 in a parameter K and 1 in a parameter J (605). The parameter K is a parameter representing an order of the largeness of a load volume, and the parameter J is a parameter representing an order of the largeness of a use frequency.

Subsequently to step 605, the moving data determination unit 108 references the execution server load list 113 and extracts the execution server 1131 whose load volume 1132 is the K-th largest (comparable to the execution server 101). The moving data determination unit 108 then references the job/data disposition table 109 and data use frequency table 110, and extracts data 125 (comparable to the account number 1101), the use frequency 1102 of which is the J-th largest, from among the data items 125 (comparable to the account numbers 1093) preserved in the extracted execution server 101 (comparable to the execution server 1091) (606).

Further, at step 606, the moving data determination unit 108 tentatively produces the job/data disposition table 109 on the assumption that the extracted data 125 whose use frequency is the J-th largest among the data items 125 preserved in the execution server 101 whose load volume 1132 is the K-th largest is moved to the execution server 101-N. The tentatively produced job/data deposition table 109 is stored in a tentative storage area in a memory included in the scheduler server 100.

At step 606, the moving data determination unit 108 references the access pattern management table 111 and the tentatively produced job/data disposition table 109, and calculates the communication frequency among the execution servers 101-1 to 101-N according to the same procedure as the procedure of step 601. Specifically, the moving data determination unit 108 references the tentatively produced job/data disposition table 109 so as to extract entries, each of which contains the pair of account numbers 1111 specifying a pair of data items 125 stored in different execution servers 101, from among the entries of the access pattern management table 111. All the use frequencies 1112 in the extracted entries are summated, whereby the communication frequency among the execution servers 101-1 to 101-N is calculated.

Subsequently to step 606, the moving data determination unit 108 decides whether the calculated communication frequency among the execution servers 101-1 to 101-N is equal to or larger than a threshold of communication frequencies designated with the command for server scale-out 131 (607). Specifically, the moving data determination unit 108 decides at step 607 whether the communication frequency is equal to or larger than the threshold on the assumption that the data 125 whose use frequency is the J-th largest among the data items 125 in the execution server 101 whose load is the K-th largest is moved to the execution server 101-N.

The moving data determination unit 108 in the present embodiment moves the data, the use frequency of which is large, to the execution server 101-N, and thus alleviates the loads on the execution servers 101. However, assuming that the data 125 whose use frequency is large is the data 125 to be referenced by a linkage job, if the data 125 whose use frequency is large is moved to the execution server 101-N, the communication frequency may be raised. Therefore, the moving data determination unit 108 decides at step 607 whether the communication frequency among the execution servers 101 is equal to or larger than the threshold of communication frequencies designated with the command for server scale-out 131.

If a decision is made at step 607 that the calculated communication frequency among the execution servers 101-1 to 101-N is equal to or larger than the threshold of communication frequencies designated with the command for server scale-out 131, the communication frequency among the execution servers 101 is equal to or larger than the communication frequency designated by an administrator. The moving data determination unit 108 does not move the data 125, the use frequency of which is the J-th largest, to the execution server 101-N, but deletes the tentatively produced job/data disposition table 109. The moving data determination unit 108 then proceeds to step 610.

If a decision is made at step 607 that the calculated communication frequency among the execution servers 101-1 to 101-N is smaller than the threshold of communication frequencies designated with the command for server scale-out 131, the communication frequency among the execution servers 101 is smaller than the communication frequency designated by an administrator. The moving data determination unit 108 proceeds to step 608.

Subsequently to step 607, the moving data determination unit 108 decides whether the difference between the load volume of the execution server 101-N and the load volume of the execution server, the load volume of which is the K-th largest, to be attained after the data 125 whose use frequency is the J-th largest is moved to the execution server 101-N is smaller than that attained before the data 125 is moved.

More particularly, the moving data determination unit 108 calculates the difference between the load volume 1132 of the execution server 101-N and the load volume 1132 of the execution server 101, the load volume 1132 of which is the K-th largest, attained before the data 125 whose use frequency 1102 is the J-th largest is moved to the execution server 101-N, and calculates the difference between the load volume 1132 of the execution server 101-N and the load volume 1132 of the execution server 101, the load volume 1132 of which is the K-th largest, to be attained after the data 125 whose use frequency 1102 is the J-th largest is moved to the execution server 101-N. The two calculated differences are compared with each other in order to decide whether the difference to be attained after the data 125 whose use frequency 1102 is the J-th largest is moved to the execution server 101-N is smaller (608).

For the processing at step 608, any calculation method may be adopted as long as a decision can be made on whether the load volume 1132 of the execution server 101-N is larger than the load volume 1132 of the execution server 101 that is a moving source of the data 125, and whether the difference between the load volume 1132 of the execution server 101-N and the load volume 1132 of the execution server 101 that is the moving source of the data 125 increases.

For example, the moving data determination unit 108 may add the user frequency 1102 of the data 125, the use frequency of which is the J-th largest, to the load volume of the execution server 101-N, and may thus calculate a new load volume of the execution server 101-N on the assumption that the data 125 whose use frequency is the J-th largest is moved to the execution server 101-N. In addition, the moving data determination unit 108 may subtract the use frequency 1102 of the data 125, the use frequency of which is the J-th largest, from the load volume 1132 of the execution server 1131 whose load volume 1132 is the K-th largest, and may thus calculate a new load volume of the execution server 101, the load volume 1132 of which is the K-th largest, on the assumption that the data 125 whose use frequency is the J-th largest is moved to the execution server 101-N. The moving data determination unit 108 may calculate the difference between the calculated new load volume of the execution server 101-N and the new load volume of the execution server 101, the load volume 1132 of which is the K-th largest, through subtraction.

If a decision is made at step 608 that the difference between the load volume 1132 of the execution server 101-N and the load volume 1132 of the execution server whose load volume 1132 is the K-th largest is increased by moving the data 125, the load volume 1132 of the execution server 101-N becomes excessive, and the loads on the execution servers 101 are not leveled. Therefore, the moving data determination unit 108 does not move the data 125, the use frequency of which is the J-th largest, to the execution server 101-N, but deletes the job/data deposition table 109 tentatively produced at step 606. The moving data determination unit 108 then proceeds to step 610.

If a decision is made at step 608 that the difference between the load volume 1132 of the execution server 101-N and the load volume 1132 of the execution server 101, the load volume 1132 of which is the K-th largest, is diminished by moving the data 125, the loads on all the execution servers 101 are leveled. Therefore, the moving data determination unit 108 determines that the data 125, the use frequency of which is the J-th largest, among the data items 125 preserved by the execution server 101 whose load volume 1132 is the K-th largest is moved to the execution server 101-N (609). The job/data disposition table 109 of the scheduler server 100 is updated with the job/data disposition table 109 tentatively produced at step 606.

Subsequently to step 609, the moving data determination unit 108 returns to step 604. At step 604, the moving data determination unit 108 produces the execution server load list 113 on the assumption that the data 125 determined at step 609 is moved to the execution server 101-N.

Thereafter, the moving data determination unit 108 proceeds to step 605, and stores is in the parameter K and parameter J respectively. After the moving data determination unit 108 of the scheduler server 100 in the present embodiment determines at step 605 the data 125 to be moved to the execution server 101-N, the moving data determination unit 108 can re-extract the execution server 101 whose load volume 1132 is the largest. Specifically, the moving data determination unit 108 of the scheduler server 100 in the present embodiment can extract the execution server 101 whose load volume 1132 should be reduced most greatly.

Subsequently to step 607 or step 608, the moving data determination unit 108 adds 1 to the parameter J so as to select the data 125 whose use frequency is the largest next to the j-th largest.

The moving data determination unit 108 decides whether the value of the parameter J is larger than the number of data items 125 preserved by the execution server 101 whose load volume 1132 is the K-th largest (611). If the value of the parameter J is equal to or smaller than the number of data items 125 preserved by the execution server 101 whose load volume 1132 is the K-th largest, since a decision has not been made on whether all the data items 125 preserved by the execution server 101 whose load volume 1132 is the K-th largest can be moved to the execution server 101-N, the moving data determination unit 108 returns to step 606.

If the value of the parameter J is larger than the number of data items 125 preserved by the execution server 101 whose load volume 1132 is the K-th largest, the moving data determination unit 108 proceeds to step 612 so as to determine whether the data items 125 preserved by the execution server 101 whose load volume 1132 is the largest next to the K-th largest are moved to the execution server 101-N. The moving data determination unit 108 adds 1 to the parameter K, and stores 1 in the parameter J (612).

Subsequently to step 612, the moving data determination unit 108 decides whether the parameters K and N are equal to each other (613). When the parameters K and N are different from each other, since a decision has not been made on whether the data items 125 preserved by all the existing execution servers 101-1 to 101-(N−1) are moved to the execution server 101-N, the moving data determination unit 108 proceeds to step 606.

If a decision is made at step 612 that the parameters K and N are equal to each other, since a decision has been made on whether the data items 125 preserved by the existing execution servers 101-1 to 101-(N−1) are moved to the execution server 101-N, the moving data determination unit 108 terminates the processing presented in FIG. 6.

After the moving data determination unit 108 decides the data 125, which are moved, through the processing presented in FIG. 6, the moving data determination unit 108 instructs the data transmitting/receiving unit 123 of the execution server 101, which is a moving source of the data 125, to move the data 125. In addition, the moving data determination unit 108 transmits the job/data disposition table 109, which is updated through the processing presented in FIG. 6, to the execution server 101.

Accordingly, the job/data disposition table 109 and data 125 are stored in the execution server 101-N.

As mentioned above, when the execution server 101-N is added to the computer system of the present embodiment, the computer system can determine the data 125 to be moved to the execution server 101-N. When the data 125 to be moved is determined, since both the processing of making a decision with an emphasis put on leveling of the load volumes 1132 of the execution servers 101 and the processing of making a decision with an emphasis put on reduction of the communication frequency among the execution servers 101 are carried out, a job execution environment more optimal to an administrator or the like can be produced.

The above description is applied to a computer system in which N is equal to or larger than 3, that is, the number of existing execution servers 101 is two or more. Even when N is 2, that is, the number of existing execution servers 101 is only one, the computer system of the present embodiment is effective. When N is 2, the processing beginning with step 604 in FIG. 6 is executed.

FIG. 8 is a flowchart presenting a procedure of determining data 125, which is moved to the execution server 101-N in the embodiment of the present invention, by giving priority to a communication frequency.

After receiving the command for server scale-out 131, the moving data determination unit 108 determines that the pair of data items 125 stored in the different execution servers 101 and specified in any of the entries of the access pattern management table 111 is moved to the execution server 101-N (801).

The processing presented in FIG. 8 can achieve both leveling of loads on the execution servers 101 and reduction of a communication frequency especially in case N is a small value such as 3. Therefore, the processing presented in FIG. 6 and the processing presented in FIG. 8 may be executed according to the number of execution servers 101.

According to the present embodiment, leveling of loads on the execution servers 101, reduction of a communication frequency, or both of them can be achieved in response to a request from an administrator or the like. For reduction of the communication frequency, the pair of data items 125 which is processed by a linkage job at a large frequency, or the pair of data items 125 which is successively processed at a large frequency is extracted, and determined to be added to the execution server 101-N. Therefore, the communication frequency can be more efficiently reduced.

The present invention has been described with reference to the appended drawings. However, the present invention is not limited to the concrete components, but encompasses various modifications and similar components within the scope of the appended claims.

1. A computer system comprising a plurality of execution servers that execute a plurality of jobs, and a scheduler server connected to the execution servers, wherein:
the execution servers each preserve a plurality of data items to be processed by the jobs;
the scheduler server produces a plurality of first pairs, each of which includes a plurality of data items to be processed by the plurality of jobs that is successively executed;
the scheduler server extracts a second pair, which includes data preserved by one of the execution servers and data preserved by any other execution server, from among the plurality of first pairs;
the scheduler server determines data items, which are included in the extracted second pair, as data items to be moved to a newly added execution server;
the computer system can enter a first state in which the data items included in the second pair have not been moved;
the scheduler server calculates a first frequency at which each of the data items is processed by the job in the first state, and a second frequency at which the plurality of data items included in the second pair is processed by the plurality of lobs to be successively executed;
the scheduler server performs first comparison of comparing the second frequency with a predetermined threshold;
if a decision is made through the first comparison that the second frequency in the first state is larger, the scheduler server determines the data items, which are included in the extracted second pair, as the data items to be moved to the newly added execution server; and
if a decision is made through the first comparison that the second frequency in the first state is smaller, the scheduler server calculates a load volume of each of the execution servers by summating the first frequencies, and determines data, which is extracted according to a plurality of calculated load volumes, as data to be moved to the newly added execution server.

2. (canceled)

3. (canceled)

4. A computer system comprising a plurality of execution servers that execute a plurality of jobs and a scheduler server connected to the execution servers, wherein:
the execution servers each preserve a plurality of data items to be processed by the jobs;
the scheduler server acquires first pairs including the plurality of data items to be successively processed;
the scheduler server extracts a second pair, which includes data preserved by one of the execution servers and data preserved by any other execution server, from among the plurality of first pairs;
the scheduler server determines data items, which are included in the extracted second pair, as data items to be moved to a newly added execution server;
the computer system can enter a first state in which the data items included in the second pair have not been moved;
the scheduler server calculates a first frequency at which each of the data items is processed by the job in the first state, and a second frequency at which the second pair is successively processed;
the scheduler server performs first comparison of comparing the second frequency with a predetermined threshold;
the computer system can enter a second state, in which the data extracted according to the plurality of calculated load volumes has not been moved, and a third state in which the data has been moved;
if a decision is made through the first comparison that the second frequency in the first state is smaller, the scheduler server calculates the second frequency in the third state, and performs second comparison of comparing the second frequency in the third state with the predetermined threshold;
if a decision is made through the second comparison that the second frequency in the third state is smaller, the scheduler server calculates a first difference between the load volume of each of the execution servers in the second state and the load volume of the newly added execution server, calculates a second difference between the load volume of each of the execution servers in the third state and the load volume of the newly added execution server, and performs third comparison of comparing the first difference with the second difference; and
if a decision is made through the third comparison that the second difference is smaller, the scheduler server determines the data, which is extracted according to the load volumes, as the data to be moved to the newly added execution server.

5. The computer system as set forth in claim 4, wherein:
if a decision is made through the first comparison that the second frequency in the first state is larger, the scheduler server determines the data items, which are included in the extracted second pair, as the data items to be moved to the newly added execution server; and
if a decision is made through the first comparison that the second frequency in the first state is smaller, the scheduler server calculates a load volume of each of the execution servers by summating the first frequencies, and determines data, which is extracted according to a plurality of calculated load volumes, as data to be moved to the newly added execution server.

6. (canceled)

7. A data management method that is a moving data determination method implemented by a scheduler server connected to a plurality of execution servers that execute a plurality of jobs, wherein:
the execution servers each preserve in a memory a plurality of data items to be processed by the jobs; and
the method is such that:
the scheduler server produces a plurality of first pairs each including a plurality of data items to be processed by the plurality of jobs that is successively executed, and stores the produced first pairs in the memory;
the scheduler server extracts a second pair, which includes data preserved by one of the execution servers and data preserved by any other execution server, from among the plurality of first pairs stored in the memory;
the scheduler server determines data items, which are included in the extracted second pair, as data items to be moved to a newly added execution server;
the plurality of execution servers and scheduler server are included in a computer system;
the computer system can enter a first state in which the data items included in the second pair have not been moved, a second state in which the data has not been moved, and a third state in which the data has been moved;
the scheduler server calculates a first frequency at which each of the data items is processed by the job in the first state, and a second frequency at which the plurality of data items included in the second pair is processed by the plurality of lobs to be successively executed;
the scheduler server performs first comparison of comparing the second frequency with a predetermined threshold;
if a decision is made through the first comparison that the second frequency in the first state is larger, the scheduler server determines the data items, which are included in the extracted second pair, as the data items to be moved to the newly added execution server;
if a decision is made through the first comparison that the second frequency in the first state is smaller, the scheduler server calculates a load volume of each of the execution servers by summating the first frequencies, and determines data, which is extracted according to a plurality of calculated load volumes, as the data to be moved to the newly added execution server;
if a decision is made through the first comparison that the second frequency in the first state is smaller, the scheduler server calculates the second frequency in the third state, and performs second comparison of comparing the second frequency in the third state with the predetermined threshold;
if a decision is made through the second comparison that the second frequency in the third state is smaller, the scheduler server calculates a first difference between the load volume of each of the execution servers in the second state and the load volume of the newly added execution server, and a second difference between the load volume of each of the execution servers in the third state and the load volume of the newly added execution server, and performs third comparison of comparing the first difference with the second difference; and
if a decision is made through the third comparison that the second difference is smaller, the scheduler server determines the data, which is extracted according to the load volumes, as the data to be moved to the newly added execution server.

8. (canceled)

9. A data management method that is a moving data determination method implemented by a scheduler server connected to a plurality of execution servers that execute a plurality of jobs, wherein:
the execution servers each preserve a plurality of data items to be processed by the jobs; and
the method is such that:
the scheduler server stores a plurality of first pairs, which includes the plurality of data items to be successively processed, in a memory;
the scheduler server extracts a second pair, which includes data preserved by one of the execution servers and data preserved by any other execution server, from among the plurality of first pairs stored in the memory;
the scheduler server determines data items, which are included in the extracted second pair, as data items to be moved to a newly added execution server;
the plurality of execution servers and scheduler server are included in a computer system;
the computer system can enter a first state in which the data items included in the second pair have not been moved, a second state in which the data has not been moved, and a third state in which the data has been moved;
the scheduler server calculates a first frequency, at which each of the data items is processed by the job in the first state, and a second frequency at which the second pair is successively processed;
the scheduler server performs first comparison of comparing the second frequency with a predetermined threshold;
if a decision is made through the first comparison that the second frequency in the first state is larger, the scheduler server determines the data items, which are included in the extracted second pair, as the data items to be moved to the newly added execution server;
if a decision is made through the first comparison that the second frequency in the first state is smaller, the scheduler server calculates a load volume of each of the execution servers by summating the first frequencies, and determines the data, which is extracted according to a plurality of calculated load volumes, as the data to be moved to the newly added execution server;
if a decision is made that the second frequency in the first state is smaller, the scheduler server calculates the second frequency in the third state, and performs second comparison on the second frequency in the third state and the predetermined threshold;
if a decision is made through the second comparison that the second frequency in the third state is smaller, the scheduler server calculates a first difference between the load volume of each of the execution servers in the second state and the load volume of the newly added execution server, and a second difference between the load volume of each of the execution servers in the third state and the load volume of the newly added execution server, and performs third comparison of comparing the first difference with the second difference; and
if a decision is made through the third comparison that the second difference is smaller, the scheduler server determines the data, which is extracted according to the load volumes, as the data to be moved to the newly added execution server.

10. (canceled)
